(19) United States
(12) Patent Application Publication
(10) Pub. No.: US 2008/0132413 A1
(43) Pub. Date: Jun. 5, 2008

(54) Methods for the Improvement of Plant Tolerance Towards Glyphosate

(75) Inventors: Michael Deall, Burscheid (DE); Jens Hartmann, Mumbai (IN); Kai-Uwe Bruggen, Mumbai (IN); Wolfgang Thielert, Odenthal (DE); Robert Steffens, Cary, NC (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Cropscience AG, Monheim (DE)

(21) Appl. No.: 11/573,084

(22) PCT Filed: Jul. 21, 2005
(86) PCT No.: PCT/EP2005/007947

§ 371 Date: Aug. 3, 2007

(30) Foreign Application Priority Data
Aug. 3, 2004 (DE) 102004037506.2

(51) Int. Cl. A01N 25/32; A01N 25/30; A01P 15/00

(52) U.S. Cl. 504/105; 504/358; 504/106

(57) ABSTRACT

The present application concerns methods for the improvement of the tolerance of certain genetically modified plants towards the use of glyphosate.

The present invention concerns methods for the improvement of the tolerance of certain genetically modified plants towards the use of glyphosate.

A series of cultigens that are genetically modified in such a way as to exhibit tolerance towards glyphosate are today commercially available and planted in many places.

Such glyphosate-resistant cultigens include, for example, sugar beet, rape, soy, cotton and maize. It is possible that in the future further plants will be added.

Glyphosate is the active component of the herbicide Roundup. It acts toxically against almost all plant varieties (non-selective) and has therefore been used for about 25 years world-wide as a so-called general herbicide (for example in weed control on fallow areas). The use for weed control in, for example soy, rape or maize cultivation was in principle not possible because of this non-selective action since the cultigens were also damaged. Only with the development of glyphosate-resistant cultigens with the aid of genetic engineering procedures could Roundup also be used here for weed control. Roundup is thus the so-called complementary herbicide for Roundup-tolerant cultigens.

Glyphosate is sprayed onto the leaves and is transported further in the plant (systemic action). The action on the ground is very low. Glyphosate inhibits the enzyme EPSP synthase in the metabolism of most plants. This enzyme is necessary for the production of essential aromatic amino acids. If these cannot be produced after application of Roundup the plant ceases to grow and dies after a few days.

The gene for CP-4EPSP synthase from the ground bacterium Agrobacterium tumefaciens, which because of structural differences to plant EPSP synthase is not inhibited by glyphosate, was transferred to genetically modified cultigens. In this way the plant can also produce aromatic amino acids in the presence of glyphosate.

Thus the plants should suffer no damage through the application of glyphosate. This is not unrestrictedly the case, however. Moreover it is known that the application of glyphosate is subject to certain restrictions in respect of time of application, the amount applied, and the frequency of application. It is further known that the application of glyphosate after the 4 leaf stage can lead to damage to the plant (cf. Pline, W., Ph.D. Thesis North Carolina State University, 2002; http://www.cals.ncsu.edu/agcomm/magazine/spring02/whenroun.htm). The use of glyphosate at a stage later than the 4 leaf stage is critical especially with rape and cotton (cf. Roundup Original, Complete Directions for Use, Label of 20. November 2002 und Roundup WeatherMAX, Complete Directions for Use, Label of 4. November 2002). For example in rape the following damage can occur: leaf yellowing, leaf necrosis, growth inhibition, flowering delay, flower deformation, flower necrosis, premature bud loss, stamen and stigma deformation, reduction in pollen count, pollen deformation, pollen fertility disorders, reduction in flower protein, yield loss. In cotton: leaf yellowing, leaf necrosis, growth inhibition, flowering delay, flower deformation, flower necrosis, premature bud loss, cavitation, stamen and stigma deformation, reduction in pollen count, pollen deformation, pollen fertility disorders, reduction in flower protein, yield loss.

The treatment of glyphosate-resistant cotton (Roundup Ready Cotton), which was grown from imidacloprid-treated seed, with the isopropylamine salt of glyphosate is known from U.S. Pat. No. 6,407,316. If the treatment was undertaken at the 4 leaf stage, after 45 days there was an 18% increase in buds compared to a control not treated with imidacloprid, while the sum of the counts of buds and bolls after 62 days matched that of the untreated control. If the treatment was carried out at the 6 leaf stage there was a minus of 14% of buds after 40 days compared to the control not treated with imidacloprid, although after 57 days the sum of the counts of buds and bolls and thus the yield was about 14% greater than that of the untreated control.

The disadvantage of this procedure is, however, the active component concentration necessary in plants for the safening effect after seed treatment with imidacloprid—depending on the amount of active compound applied per unit of seed, depending on the variability of active component uptake conditions such as in particular ground water availability, temperature, soil type, soil texture, organic C content, active component absorption, active component degradation in the soil as well as planting measures such as seed amount, seed depth, row separation, seed separation in the row, fertilisation and in particular type-typical properties such as seed size, root formation, uptake capacity, distribution within the plant as well as metabolism of the active component in the plant—is subject to considerable variation and thus the desired reduction of the damaging effects of glyphosate spray treatment in Roundup Ready cotton and Roundup Ready rape beyond the 4 leaf stage is not always guaranteed.

The task of the invention was to make a method available that avoids the named disadvantages and allows the use of glyphosate in glyphosate-resistant cultigens of in particular cotton and rape over a greater time interval without plant damage arising.

It was now found that after a spray application of one or more insecticides from the series of the neonicotinoids to glyphosate-resistant plants a subsequent application of glyphosate leads to less plant damage than with plants that were not previously sprayed with insecticide. Moreover the period in which glyphosate can be applied is extended. It was further found that a spray application of a mixture containing one or more insecticides from the series of neonicotinoids and glyphosate is also still possible at a time point at which the application of glyphosate alone would lead to plant damage. In addition it was found that after seed treatment with imidacloprid and subsequent spray treatment with one or more insecticides from the series of the neonicotinoids to glyphosate-resistant plants a subsequent application of glyphosate leads to less plant damage than with plants that were not previously treated with imidacloprid, and that the period over which glyphosate could be used was extended. It was further found that after seed treatment with imidacloprid the subsequent spray application of a mixture containing one or more insecticides from the series of the neonicotinoids and glyphosate was also possible at a time point at which the application of glyphosate alone would lead to plant damage.

The ground in which the glyphosate-resistant plants are planted out can be treated before, during or after the planting of the seeds with one or more insecticides from the series of the neonicotinoids.

Insecticide from the series of the neonicotinoids may be described by the following structure (I)

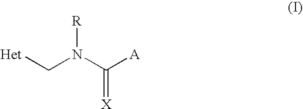

wherein
Het stands for a heterocycle selected from the following group of heterocycles:
   2-chloropyrid-5-yl, 2-methylpyrid-5-yl, 1-oxido-3-pyridinio, 2-chloro-1-oxido-5-pyridinio, 2,3-dichloro-1-oxido-5-pyridinio, tetrahydrofuran-3-yl, 5-methyl-tetrahydrofuran-3-yl, 2-chlorothiazol-5-yl,
A stands for —N(R¹)(R²) or S(R²),
   wherein
   R¹ stands for hydrogen, C₁-C₆-alkyl, phenyl-C₁-C₄-alkyl, C₃-C₆-cycloalkyl, C₂-C₆-alkenyl or C₂-C₆-alkinyl, and
   R² stands for C₁-C₆-alkyl, C₂-C₆-alkenyl, C₂-C₆-alkinyl, —C(═O)—CH₃ or benzyl,
R stands for C₁-C₆-alkyl, C₂-C₆-alkenyl, C₂-C₆-alkinyl, —C(═O)—CH₃ or benzyl or together with R² stands for one of the following groups:
   —CH₂—CH₂—, —CH₂—CH₂—CH₂—, —CH₂—O—CH₂—, —CH₂—S—CH₂—, —CH₂—NH—CH₂—, —CH₂—N(CH₃)—CH₂—, and
X stands for N—NO₂, N—CN or CH—NO₂,
   (see, for example, EP-A1-192 606, EP-A2-580 533, EP-A2-376 279, EP-A2-235 725).

The following compounds which can be used in accordance with the invention are named in particular.

One compound used preferably according to the patent is thiamethoxam.

Thiamethoxam has the structure

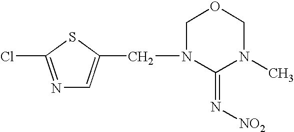

and is known from EP A2 0 580 553.

A further compound used preferably according to the invention is clothianidin.

Clothianidin has the structure

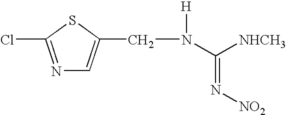

and is known from EP A2 0 376 279.

A further compound used preferably according to the invention is thiacloprid.

Thiacloprid has the structure

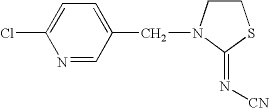

and is known from EP A2 0 235 725.

A further compound used preferably according to the invention is dinotefuran.

Dinotefuran has the structure

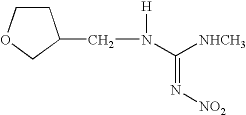

and is known from EP A10 649 845.

A further compound used preferably according to the invention is acetamiprid.

Acetamiprid has the structure

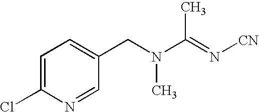

and is known from WO A1 91/04965.

A further compound used preferably according to the invention is nitenpyram.

Nitenpyram has the structure

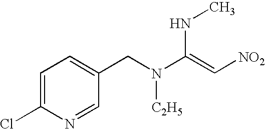

and is known from EP A2 0 302 389.

A further compound used preferably according to the invention is imidacloprid.

Imidacloprid has the structure

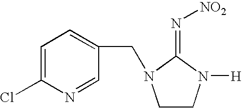

and is known from EP 0 192 060.

According to the invention the compounds more preferably used are imidacloprid and thiacloprid. According to the invention imidacloprid is most preferably used.

The term glyphosate includes here also salts of glyphosate, for example the ammonium salt, the isopropylamine salt, the potassium salt, the sodium salt and the trimethylsulphonium salt (glyphosate-trimesium).

In the separated application (spraying sequence) of neonicotinoid and glyphosate the neonicotinoid is first applied to the plants. For this it is converted into a conventional spray formulation.

These formulations are made up in a known manner, e.g. by mixing the active components with diluents, that is liquid solvents, optionally with the use of surfactants, that is emulsifiers and/or dispersants and/or foaming agents.

In the case of the use of water as solvent organic solvents for example can also be used as auxiliary solvents. Suitable liquid solvents are essentially: aromatics such as xylene, toluene or alkylnaphthalines, chlorinated aromatics and chlorinated aliphatic hydrocarbons such as chlorobenzenes, chloroethylenes or methylene chloride, aliphatic hydrocarbons such as cyclohexane or paraffins, e.g. natural oil fractions, mineral and vegetable oils, alcohols such as butanol or glycol as well as their ethers and esters, ketones such as acetone, methylethylketone, methylisobutylketone or cyclohexanone, strongly polar solvents such as dimethylformamide and dimethylsulphoxide as well as water.

The treatment with the neonicotinoid can be normally carried out after reaching damage thresholds of the controllable pests as well as for promotion of plant health and yield in compliance with the regional application recommendations in the directions after emergence of the plants up to immediately before the harvest with consideration of the prescribed harvest interval. For imidacloprid, the active component in, for example TRIMAX SC 480, authorised especially for spray application to cotton, USA (EPA Reg. No. 264-783), 5 spray applications with a spraying interval of 7 days up to 14 days before the harvest are permitted. The maximum single dose of TRIMAX SC 480 per hectare is here 52.7 g active component imidacloprid, the maximum total dose TRIMAX SC 480 per hectare and cultigen season is 263.3 g active compound imidacloprid. According to experience TRIMAX SC 480 is, because of the typical regional infestation course, used intensively from the 4 leaf stage to the 10 leaf stage in cotton.

For the post-emergence treatment with glyphosate in cotton with the Roundup Ready Gene, 1.61 Roundup WeatherMAX/ha from emergence up to the 4 leaf stage is recommended, for example. Roundup WeatherMAX contained 660 g glyphosate K salt per litre, corresponding to 540 g glyphosate acid equivalents per litre. In cases of massive weed infestation after the 4 leaf stage which can lead to total loss of the cultivation an additional post-emergence treatment with 1.61/ha can take place as so-called “rescue treatment”, but which can, however, be associated with considerable plant damage and thus yield losses.

For post-emergence treatment with glyphosate in rape with the Roundup Ready gene 0.8-1.171 Roundup WeatherMAX/ha from emergence up to maximally the 6 leaf stage is recommended for example when an application of more than, for example, 0.81 Roundup WeatherMAX should not be exceeded after the 4 leaf stage because of the risk of plant damage and yield losses. Glyphosate is preferably used in the normal commercial formulations such as Roundup Original, Roundup WeatherMAX, Roundup Original II, Roundup Original Max, Roundup Ultra, Roundup UltraDry, Roundup UltraMAX, Roundup UltraMAX II, Touchdown IQ, Touchdown HiTech, Touchdown Total.

In the plants treated according to the invention significantly less damage occurs through treatment with glyphosate and/or the period during which treatment with glyphosate can be carried out is significantly extended, when in particular up to 7 days before the necessary glyphosate treatment a spray with imidacloprid, e.g. TRIMAX SC 480 at the recommended dose rate is carried out. This has the advantage that, for example, weather-dependent delays in weed control or insufficiently effective weed control measures can be made good with glyphosate beyond the critical development stages of cotton or rape described in the directions with significantly less plant damage. A further advantage is to be seen in the reduction of damage within the overlap region of spray jets or spray bars. Examples of plant damage are leaf yellowing, leaf necrosis, growth inhibition, flowering delay, flower deformation, flower necrosis, premature flower bud loss, cavitation, stamen and stigma deformation, reduction in pollen count, pollen deformation, pollen fertility disorders, reduction in flower protein, yield loss.

In combined application of neonicotinoid and glyphosate both active components are applied to the plants either with the authorised single commercial products in a tank mixture or as a ready-mixed formulation. Suitable ready-made formulations that contain both active components can be selected from normally used formulation types.

The content of neonicotinoid and glyphosate acid equivalents of the tank mixtures or ready-made formulation used according to the invention can be varied over a wider range. In general high success is achieved by complying with the application quantities given by the manufacturers. An applied amount of about 50-100 g imidacloprid/ha with an applied amount of 850 to 1750 g glyphosate acid/ha has proved to be particularly advantageous.

The mixtures described here contain both at least one neonicotinoid and glyphosate, are new and also subject matter of the invention.

The mixtures of the invention can be applied to the plants up to 14 days before the harvest, when the use of glyphosate alone would lead to considerable plant damage. This has the advantage that, for example, weather-dependent delays in weed control or insufficiently effective weed control measures can be made good with glyphosate beyond the critical development stages of cotton or rape described in the directions with significantly less plant damage. A further advantage is to be seen in the reduction of damage in the overlap region of spray jets and spray bars.

A further aspect of the present invention is the use of seed of glyphosate-resistant plants that was treated with one or more insecticides from the series of the neonicotinoids.

Within the context of the present invention the insecticide is applied to the seed alone or in a suitable formulation. Preferably the seed is handled in a state in which it is so stable, that no damage occurs at any time point between harvest and sowing. Normally seed is used that was separated from the plant and was freed of spadices, stalks, husks, wool or fruit flesh.

In general care must be taken during the treatment of the seed that the amount of the agent of the invention and/or further additives applied to the seed is so chosen that the germination of the seed is not impaired and the resulting plant is not damaged. This is to be noted above all with active compounds which can show phytotoxic effects when applied in certain amounts.

The agents of the invention can be applied directly, that is without containing additional components and without being diluted. It is normally preferred to apply the agent to the seed in the form of a suitable formulation. Suitable formulations and methods for seed treatment are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

### EXAMPLE

Cotton seed of the type Stoneville ST 4892 BR (Stoneville Seed Company, Memphis Tenn.; glyphosate resistant (RR MON event 1445)+Bacillus thuringiensis endotoxin (MON event 531), untreated and Gaucho (imidacloprid) treated were sown in 3 litre plastic containers in standardised plant earth and grown in a greenhouse at 25° C., 70 to 80% relative humidity and 14 hours natural and artificial light (Na vapour lamps).

Ground treatment with Temik granulate (Aldicarb) was carried out after emergence by incorporation of the corresponding amount of granulate in the upper earth around the plant stem. Trimax SC480 (obtainable from Bayer CropScience) was applied until dripping wet with a 11 Gloria hand spray apparatus in the 4 leaf stage, Round Ultra (glyphosate, obtainable from Monsanto) with a 51 backpack sprayer in the 6 leaf stage with a water application equivalent to 3001/ha. The results are illustrated in the following table.

| | | Total % necrosis at |
|---|---|---|
| | | leaf embranchment 1 to 6. |
| | | Mean of 6 test plants |
| | Applied | 15 days after Roundup |
| | amount | Ultra treatment |
| Untreated | | 0 |
| Roundup Ultra SL 360 | 4.7 l/ha | 87.0 |
| Temik GR 15 u | 5.6 kg u | 101.3 |
| Roundup Ultra | 4.7 l/ha | |
| Gaucho FS 600 u | 8.4 ml/kg u | 55.7 |
| Roundup Ultra | 4.7 l/ha | |
| Trimax SC 480 + | 1.080 + 0.108 | 31.3 |
| Kinetic* u | l/ha u | |
| Roundup Ultra | 4.7 l/ha | |
| Temiku | 5.6 kg u | 32.8 |
| Trimax + | 1.080 + 0.108 | |
| Kinetic* u | l/ha u | |
| Roundup Ultra | 4.7 l/ha | |
| Gaucho u | 8.4 ml/kg u | 25.5 |
| Trimax + | 1.080 + 0.108 | |
| Kinetic* u | l/ha u | |
| Roundup Ultra | 4.7 l/ha | |

u = sequential treatment;
*= auxiliary (obtainable for example from Helena Chemical Company Fresno, CA 93711)

1. A method for reducing plant damage in glyphosate-resistant plants comprising contacting the plants with one or more neonicotinoids prior to the application of glyphosate.

2. A method for extending the period during which glyphosate can be used in glycphosate-resistant cultigens comprising administering a spray application of one or more neonicotinoids to the cultigens prior to the application of glyphosate.

3. The method of claim 1, wherein the seed of the glyphosate-resistant plants is treated with one or more neonicotinoids.

4. The method of claim 1, wherein the ground in which the glyphosate-resistant plants are planted is treated with one or more neonicotinids before, during or after the sowing of the glyphosate-resistant plant seed.

5. A method for reducing plant damage to glyphosate-resistant plants comprising administering a spray application comprising glyphosate in admixture with one or more neonicotinoids.

6. A method for extending the period during which glyphosate can be applied to glyphosate-resistant cultures comprising applying glyphosate a spray application in admixture with one or more neonicotinoids.

7. The method of claim 5, further comprising treating the seed of the glyphosate-resistant plants is treated with one or more neonicotinoids.

8. The method of claim 5, further comprising treating the ground in which the glyphosate-resistant plants are planted with one or more neonicotinoids before, during or after sowing the seed.

9. The method of claim 2, wherein the seed of the glyphosate-resistant cultigens is treated with one or more neonicotinoids.

10. The method of claim 2, wherein the ground in which the glyphosate-resistant cultigen is planted is treated with one or more neonicotinoids before, during or after the sowing of the glyphosate-resistant cultigen seed.

11. The method of claim 3, wherein the ground in which the glyphosate-resistant seed is planted is treated with one or more neonicotinoids before, during or after the sowing of the glyphosate-resistant plant seed.

12. The method of claim 6, further comprising treating the seed of the glyphosate-resistant plants with one or more neonicotinoids.

13. The method of claim 6, further comprising treating the ground in which the glyphosate-resistant plants are planted with one or more neonicotinoids before, during or after sowing the seed.

14. The method of claim 7, further comprising treating the ground in which the glyphosate-resistant plants are planted with one or more neonicotinoids before, during or after sowing the seed.
